(19) United States
(12) Patent Application Publication
(10) Pub. No.: US 2010/0216625 A1
(43) Pub. Date: Aug. 26, 2010

(54) GLASS FOR LASER MACHINING

(75) Inventors: Masanori SHOJIYA, Tokyo (JP); Hirotaka KOYO, Tokyo (JP); Keiji TSUNETOMO, Tokyo (JP)

Correspondence Address: HAMRE, SCHUMANN, MUELLER & LARSON, P.C., P.O. BOX 2902, MINNEAPOLIS, MN, 55402-0902, US

(73) Assignee: NIPPON SHEET GLASS COMPANY, LIMITED, Tokyo (JP)

(21) Appl. No.: 12/775,254

(22) Filed: May 6, 2010

Related U.S. Application Data
(63) Continuation of application No. 10/541,175, filed on Jun. 30, 2005.

(30) Foreign Application Priority Data
Jan. 10, 2003 (JP) 2003-004208
Apr. 2, 2003 (JP) 2003-099684

(51) Int. Cl. C03C 3/085; C03C 3/12

(52) U.S. Cl. 501/41; 501/69

(57) ABSTRACT

A glass for laser processing that is processed through laser beam irradiation, wherein the glass for laser processing has a composition that satisfies the following relationships:

40≦M[NFO]≦70;

5≦(M[TiO₂])≦45; and

5≦M[NMO]≦40,

where M[NFO], M[TiO₂], and M[NMO] denote the content by percentage of network forming oxides (mol %), that of TiO₂ (mol %), and that of network modifying oxides (mol %), respectively. With this structure, a glass for laser processing is obtained in which not only the vicinity of the surface thereof but also the inner portion thereof can be laser-processed.

This application is a continuation of U.S. application Ser. No. 10/541,175, filed Jun. 30, 2005, which is a U.S. National Stage of PCT/JP2004/000085, filed Jan. 8, 2004, which applications are incorporated herein by reference.

### TECHNICAL FIELD

The present invention relates to a glass for laser processing that is suitable to be processed through laser beam irradiation.

### BACKGROUND ART

When a solid material is irradiated with a laser beam whose pulse width is in the nanosecond range or narrower, decomposition products transpire, which is accompanied by intense light emitting and an impulsive sound. This phenomenon is referred to as optical ablation, laser ablation, or simply ablation. Recently, it is used widely for microprocessing of inorganic solids such as glass, ceramics, metal, and organic substances such as polymers, etc.

Processing to be achieved through ablation is performed within a very short laser irradiation time, i.e. a time on the order of a laser beam pulse width. Accordingly, the region around the processed site is prevented from being damaged thermally, which makes it possible to carry out precise and fine processing that produces a smaller number of thermally damaged layers, as compared to thermal processing employing a continuous-wave infrared laser such as a carbon dioxide gas laser, etc.

In the processing that is carried out using an ultrashort pulse laser (a femtosecond laser), laser beam irradiation is completed before thermal diffusion occurs in a material to be processed. Accordingly, it is particularly suitable for precision processing. At present, however, ultraviolet lasers having pulse widths on the order of several nanoseconds to several tens of nanoseconds, such as an excimer laser, generally are used due to, for instance, easy handling of laser devices and other optical systems thereof. Ultraviolet light has higher energy per photon. When the photon energy is higher than the energy with which atoms, ions, and molecules that are contained in a material are bonded chemically to each other, respectively, the light can break the chemical bonds. In this case, the ultraviolet laser is suitable for the processing to be achieved through ablation.

The ease of laser processing depends on physical properties of the material to be processed. For instance, using a material that requires lower laser power to be processed results in broader options for a laser device and thus in decreased device cost. Accordingly, microprocessing can be carried out more easily at a lower cost.

A glass that is a transparent medium is a material suitable particularly for optical uses. Conceivably, the potential needs for microprocessing of such a glass are great not only in the optical uses but also in other various uses. A glass containing silver introduced thereinto through ion exchange (see, for instance, JP11(1999)-217237A) has been known as a glass suitable for laser processing, i.e. a glass characterized in a lower laser processing threshold and in that cracks tend not to occur during processing.

In an ion-exchanged glass produced by the ion exchange method, alkali metal that is present near the glass surface is exchanged for silver ions, and the silver ions that have been introduced into the glass eventually are fixed to the glass surface in the form of silver metal, silver ions, silver colloids, etc. When an ultraviolet laser is used for processing an ion-exchanged glass, it is absorbed by an absorption source associated with the silver that exists at the glass surface. This results in material evaporation caused by a rapid increase in temperature of the region around the processing site, and cleavage of chemical bonds. As a result, even when using relatively low laser power, a material can be processed through ablation.

The above-mentioned ion-exchanged glass, however, has the two following problems although it is suitable for being processed at its surface.

A first problem is that it is difficult to process the inner portion of the glass (for instance, to form a through hole). The silver ion exchange is carried out by diffusing silver ions from the glass surface. Hence, silver does not permeate to the inner portion of the glass. Accordingly, the centers of ultraviolet absorption sites (the centers with respect to silver) are concentrated near the glass surface. As a result, in the ion-exchanged glass, the area that can be processed with a laser is limited to the vicinity of the glass surface. Accordingly, it is difficult to carry out microprocessing of the inner portion of glass through laser irradiation, such as to form a through hole.

A glass whose inner portion also can be processed with a laser is difficult to form through any treatments to be carried out on the glass. It therefore is necessary to develop a homogeneous glass with a composition that facilitates laser processing. There, however, has been a basic problem in that the guideline for obtaining such a glass composition is not clear.

A second problem is that it is highly necessary to use a glass containing a large amount of alkali metal ions that can be exchanged for silver ions easily, as a mother glass to be subjected to the ion exchange. With consideration given to production cost, it is desirable to carry out the ion exchange in the shortest possible time. For this reason, it actually is difficult to eliminate the restriction on the composition. Hence, as long as the ion exchange treatment is required to be carried out, a lower thermal expansion glass and non-alkali glass that have been highly demanded for the uses such as electric circuit boards, etc. are difficult to use as a glass for laser processing.

Furthermore, there also have been demands for a glass for laser processing with a smaller thermal expansion coefficient. In laser processing, the temperature of the part irradiated with a laser beam increases. Hence, when the glass has a large thermal expansion coefficient, the processed part is deformed or damaged due to the difference in thermal expansion between the laser irradiation part and the periphery thereof, which results in a deterioration in processing accuracy. In addition, it is particularly important for a glass for laser processing to have a smaller thermal expansion coefficient when it is used as a member of a device, such as an optical device, etc., in which variations in volume caused by temperature changes need to be small.

### DISCLOSURE OF THE INVENTION

An object of the present invention is to provide a glass for laser processing in which not only the vicinity of the surface thereof but also the inner portion thereof can be laser-processed easily. Furthermore, another object of the present invention is to provide a glass for laser processing with a lower thermal expansion coefficient in which the inner portion thereof also can be laser-processed easily.

In order to achieve the above-mentioned object, a glass of the present invention is a glass for laser processing that is processed through laser beam irradiation, wherein the glass for laser processing has a composition that satisfies the following relationships:

40≦M[NFO]≦70;

5≦(M[TiO₂])≦45; and

5≦M[NMO]≦40,

where M[NFO], M[TiO₂], and M[NMO] denote the content by percentage of network forming oxides (mol %), that of TiO₂ (mol %), and that of network modifying oxides (mol %), respectively.

Another glass of the present invention is a glass for laser processing that is processed through laser beam irradiation, wherein the glass for laser processing has a composition that satisfies the following conditions:

40≦M[SiO₂]≦60;

10≦M[Al₂O₃]≦20;

10≦M[TiO₂]≦20; and

10≦M[MgO]≦35,

where M[SiO₂], M[Al₂O₃], M[TiO₂], and M[MgO] denote the content by percentage of SiO₂ (mol %), that of Al₂O₃ (mol %), that of TiO₂ (mol %), and that of MgO (mol %), respectively.

### BRIEF DESCRIPTION OF DRAWINGS

FIG. 1 is a schematic view showing an optical system used for measuring a laser processing threshold.

FIG. 2 is a graph showing the relationship between the average value fₘ of cation field strengths and the laser processing threshold Fₜₕ.

FIG. 3 is a graph showing the relationship between the average value fₘ′ of all cation field strengths and the laser processing threshold Fₜₕ.

FIG. 4 is a graph showing the relationship between the average value Fₘ of single bond strengths and the laser processing threshold Fₜₕ.

FIG. 5 is a graph showing the relationship between the average value Fₘ′ of all single bond strengths and the laser processing threshold Fₜₕ.

FIG. 6 is a graph showing the relationship between the laser processing threshold Fₜₕ and the value (Fₘ/α) obtained by dividing the average value Fₘ of single bond strengths by an absorption coefficient α.

FIG. 7 is a graph showing the relationships between the number N of Si—O—Ti bonds per SiO₄ unit and the laser processing threshold Fₜₕ as well as laser processing speed Δh.

FIG. 8 is a graph showing the relationship between the ratio of M[TiO₂]/M[SiO₂] and the number N of Si—O—Ti bonds.

FIG. 9 is a graph showing the relationships between the ratio of M[TiO₂]/M[SiO₂] and the laser processing threshold Fₜₕ as well as laser processing speed Δh.

FIG. 10 is a graph showing the relationship between the laser processing threshold Fₜₕ and the value obtained by dividing the number of bridging oxygen atoms (N_{BO}^{I} or N_{BO}) by the absorption coefficient α.

### BEST MODE FOR CARRYING OUT THE INVENTION

Preferred embodiments of the present invention are described below.

### Embodiment 1

In Embodiment 1, the description is directed to a glass that is easy to laser-process, i.e. a glass that allows laser ablation to occur with lower energy. This glass has a lower laser processing threshold Fₜₕ. For instance, when using a laser beam with a wavelength of 266 nm, the laser processing threshold Fₜₕ of this glass is preferably 500 mJ·cm⁻² or lower (more preferably 400 mJ·cm⁻² or lower). When the laser processing threshold Fₜₕ is 400 mJ·cm⁻² or lower, the glass can be laser-processed particularly easily.

Average Value fₘ of Cation Field Strengths

The important issue for obtaining a glass that is easy to laser-process is that chemical bonds can be broken easily upon laser beam irradiation. In the glass in which chemical bonds can be broken easily, it is conceivable that the average strength of chemical bonds formed among ions that constitute the glass is low. The average value fₘ of cation field strengths that conceivably reflects the average strength of chemical bonds can be defined by the following formula:

fₘ=(ΣxᵢCᵢZᵢ/(rᵢ+r₀)²)/ΣxᵢCᵢ,

wherein xᵢ denotes a molar fraction for which oxides (i) containing cations (i) other than alkali metal ions and alkaline earth metal ions account in the composition; Cᵢ indicates the number of the cations (i) included in the composition formulae of the oxides (i); Zᵢ denotes valences of the cations (i); and rᵢ and r₀ indicate values expressing ion radii of the cations (i) and oxide ions (O²⁻) by angstrom, respectively. In the formula, Σ denotes obtaining the sum of all cations (i) other than the alkali metal ions and alkaline earth metal ions of the cations contained in the glass.

When the cations (i) are Al³⁺ and oxides containing them are Al₂O₃, xᵢ denotes a molar fraction for which Al₂O₃ accounts in the composition while Cᵢ and Zᵢ are 2 and 3, respectively.

With respect to the values rᵢ and r₀ corresponding to the ion radii, values described in “R. D. Shannon, Acta Crystallogr., A32 (1976) 751” can be used that were obtained through a modification carried out by Shannon to values that Shannon and Prewitt had obtained based on their actual measurements. For instance, the values applicable to the radii of a Si⁴⁺ ion, a Ti⁴⁺ ion, and a Na⁺ ion are 0.40, 0.75, and 1.16 angstroms, respectively.

As described later, a value fₘ of 1.35 or lower makes it possible to obtain a glass that is easy to laser-process.

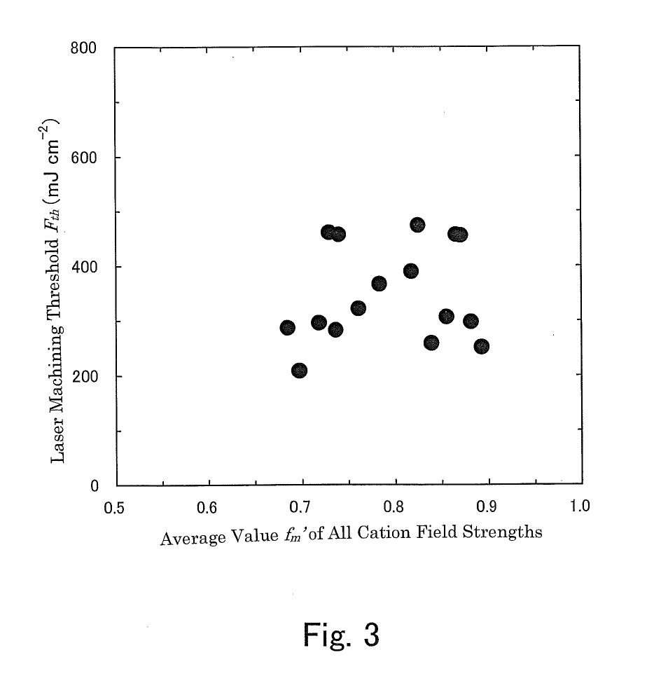

As described above, even if the composition includes alkali metal ions and/or alkaline earth metal ions, the value fₘ is calculated, with the alkali metal ions and alkaline earth metal ions being excluded from the cations (i). In this case, the alkali metal ions include Li, Na, K, Rb, and Cs ions while the alkaline earth metal ions include Mg, Ca, Sr, and Ba ions. No correlation is found between the laser processing threshold and the value fₘ′ that was calculated, with those ions being included in the cations (i) (see FIG. 3). Conceivably, this is because strengths of chemical bonds formed between the alkali metal ions and the oxide ions as well as between the alkaline earth metal ions and the oxide ions are very low and the cleavage of the bonds that occurs upon laser beam irradiation therefore is not a key factor in determining the level of laser processability.

The contributions of the alkali metal ions and the alkaline earth metal ions are excluded in calculating the value fₘ. However, there is no limitation in that a glass for laser processing of the present invention includes alkali metal oxides and/or alkaline earth metal oxides. For instance, when a glass for laser processing of the present invention is produced by a common melting method, alkali metal oxides and/or alkaline earth metal oxides may be included in the composition thereof for lowering the viscosity of the melt thereof at high temperatures, for example.

### Average Value Fₘ of Single Bond Strengths

In the case of oxide glass, in order to obtain a glass that is easy to laser-process, it also is important that oxides contained therein decompose easily. Accordingly, the average value Fₘ of single bond strengths needs to be low, which is defined by the following formula:

Fₘ=ΣxⱼCⱼE_{dj}/ΣxⱼCⱼNⱼ.

In the above formula, xⱼ. denotes a molar fraction for which oxides (j) other than alkali metal oxides and alkaline earth metal oxides account in the composition; Cⱼ indicates the number of cations (j) included in the composition formulae of the oxides (j); E_{dj} denotes dissociation energy of the oxides (j) expressed with a composition ratio of the cations (j) being 1; and Nⱼ indicates the number of oxide ions coordinated to the cations (j) in the oxides (j). In the formula, Σ denotes obtaining the sum of all cations (j) other than the alkali metal ions and alkaline earth metal ions of the cations contained in the glass.

When the cations (j) is Al³⁺ and oxide (j) containing it is Al₂O₃, xⱼ denotes a molar fraction of Al₂O₃ in the glass, Cᵢ and Nⱼ are 2 and 6, respectively, and E_{dj} is dissociation energy of Al₁O_{1.5} (half the value of dissociation energy of Al₂O₃). In this case, each oxide (j) includes only one type of cation (j).

The values E_{dj} and Nⱼ to be used for the calculation of the formula described above can be those described in “K. H. Sun, J. Amer. Ceram. Soc., 30 (1947) 277” or “A. Makishima and J. D. Mackenzie, J. Non-Cryst. Solids, 12 (1973) 35”. For instance, values of dissociation energy of SiO₂, that of TiO₂, and that of MgO can be 424 kcal·mol⁻¹, 435 kcal·mol⁻¹, and 222 kcal·mol⁻¹, respectively.

As described later, a value Fₘ of 400 kJ·mol⁻¹ (95 kcal·mol⁻¹) or lower makes it possible to obtain a glass that is easy to laser-process.

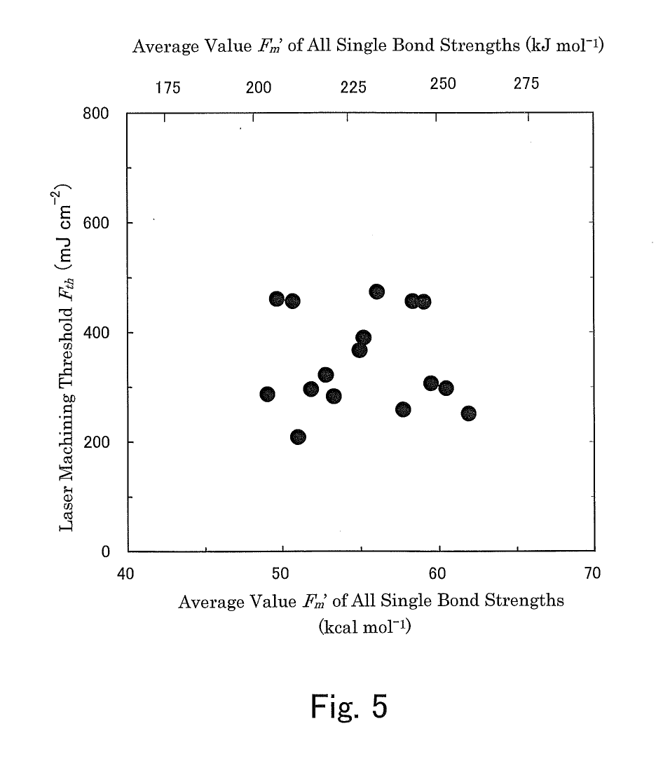

The glass for laser processing may include alkali metal oxides and/or alkaline earth metal oxides. In the calculation of the value Fₘ, however, the alkali metal oxides and alkaline earth metal oxides are excluded from the oxides (j). No correlation is found between the laser processing threshold and the value Fₘ′ that was calculated, with those oxides being included in the oxides (j) (see FIG. 5). Conceivably, this is because strengths of chemical bonds formed between the alkali metal ions and the oxide ions as well as between the alkaline earth metal ions and the oxide ions are very low and the cleavage of the bonds that occurs upon laser beam irradiation therefore is not a key factor in determining ease of laser processing.

In addition, even in the case of a glass in which bonds are broken easily, ablation does not occur unless a laser beam is absorbed effectively. Hence, the value obtained by dividing the value Fₘ defined by the above-mentioned formula by the absorption coefficient α of the glass also has a close relationship with the ease of laser processing. This value has a favorable correlation with the laser processing threshold. In this case, the value Fₘ/α is determined through a calculation that is carried out with both the units of Fₘ and α being “cm⁻¹”. Specifically, the value Fₘ expressed by the unit “cm⁻¹” can be obtained by multiplying the value Fₘ expressed by the unit “kJ·mol⁻¹” by 83.5935.

The absorption coefficient α to be used in the calculation of the value Fₘ/α is defined by the following formula (1):

Δh=α⁻¹×In(F/Fₜₕ) (1).

In the formula (1), Δh denotes an ablation processing speed and corresponds to the depth (cm) to which a glass is processed per laser pulse shot; F indicates laser fluence and denotes laser power per unit area; and Fₜₕ indicates a laser processing threshold and corresponds to the minimum laser fluence that allows ablation to occur. The absorption coefficient α can be obtained by the method to be described later.

The Number N of Si—O—Ti bonds

In a common glass composition, SiO₂ and B₂O₃ are glass network forming oxides and form the network structure of glass. On the other hand, alkali metal oxides and alkaline earth metal oxides are glass network modifying oxides. They have a function to break a part of the glass network structure when contained in the composition and therefore provide an effect of lowering viscosity of a glass melt, for instance. TiO₂ and Al₂O₃ are referred to as intermediate oxides and have intermediate properties between the properties of the glass network forming oxides and those of the glass network modifying oxides.

On the other hand, the inventors found that the increase in amount of TiO₂ allowed the laser processing threshold to decrease. In a glass of the present invention, TiO₂ is a component required for lowering the laser processing threshold.

In order to quantify the relationship between the content of TiO₂ and the laser processing threshold, a value that is referred to as the number N of Si—O—Ti bonds is introduced. When the glass composition is composed essentially of SiO₂, TiO₂, and at least one oxide selected from the alkali metal oxides and alkaline earth metal oxides, there is a correlation between the number N of Si—O—Ti bonds and the laser processing threshold, and an increase in the number N results in a decrease in the laser processing threshold as described later.

The number N of Si—O—Ti bonds per SiO₄ unit that is a glass network structure forming unit can be defined as follows. First, molar fractions of O, Si, and Ti contained in a glass are expressed as M_{O}, M_{Si}, and M_{Ti}, respectively. N_{BO}^{I} and N_{NBO}^{I} indicate the number of bridging oxygen atoms and the number of non-bridging oxygen atoms, respectively, with the glass structure being assumed to be free from Ti. In this case, the number of bridging oxygen atoms denotes the number of oxygen atoms, per SiO₄ unit, that structurally cross-link two Si atoms. On the other hand, the non-bridging oxygen denotes the number of oxygen atoms, per SiO₄ unit, that structurally do not cross-link two Si atoms.

The number N_{BO}^{I} of bridging oxygen atoms and the number N_{NBO}^{I} of non-bridging oxygen atoms in the above-mentioned glass structure are expressed by the following formulae, respectively:

N_{BO}^{I}=8−2M_{O}/M_{Si}; and

N_{NBO}^{I}=4−N_{BO}^{I}.

In this case, if the glass composition satisfies a relationship of (M_{Si}N_{NBO}^{I}−2M_{Ti})>0, the constant N_{NBO} is defined by the following formula:

N_{NBO}=(M_{Si}N_{NBO}^{I}−2M_{Ti})/M_{Si}.

That is, the constant N_{NBO} is the number of oxygen atoms, per SiO₄ unit, that still are bonded to one Si atom alone even after introduction of Ti. In this case, the number N of Si—O—Ti bonds is defined by the following formula:

N=N_{NBO}^{I}−N_{NBO}.

On the other hand, if the glass composition satisfies a relationship of (M_{Si}N_{NBO}^{I}−2M_{Ti})≦0, the constants N_{Ti} and N_{BO} are defined by the following formulae:

N_{Ti}=(2M_{Ti}−M_{Si}N_{NBO}^{I})/2, and

N_{BO}=(M_{Si}N_{BO}^{I}−N_{Ti})/M_{Si}.

In the above-mentioned formula, N_{BO} denotes the number of oxygen atoms, per SiO₄ unit, that still are cross-linking two Si atoms even after introduction of Ti. In this case, N is calculated by the following formula:

N=4−N_{BO}.

Accordingly, Nis expressed as 0≦N≦4. As described later, the value N set at 0.4 or higher makes it possible to obtain a glass that is easy to laser-process. In addition, the value N set at 1.3 or lower makes it possible to obtain a glass that can be processed at high speed.

### Composition Examples

One preferable example of the glass for laser processing according to Embodiment 1 has a composition that satisfies the following conditions:

40≦M[NFO]≦70;

5≦(M[TiO₂])≦45; and

5≦M[NMO]≦40,

where M[NFO], M[TiO₂], and M[NMO] denote the contents by percentage (mol %) for which network forming oxides, TiO₂, and network modifying oxides account in the composition, respectively.

Examples of the network forming oxides that can be used herein include SiO₂, B₂O₃, GeO₂, P₂O₅, and ZrO₂. Examples of the network modifying oxides that can be used herein include alkali metal oxides, alkaline earth metal oxides, and transition metal oxides (for instance, ZnO, Ga₂O₃, SnO₂, In₂O₃, La₂O₃, Sc₂O₃, Y₂O₃, CeO₂, MnO₂, etc.). Examples of the alkali metal oxides that can be used herein include Li₂O, Na₂O, K₂O, Rb₂O, and Cs₂O. Furthermore, examples of the alkaline earth metal oxides that can be used herein include MgO, CaO, SrO, and BaO.

In the above-mentioned composition example, the network forming oxides may be at least one oxide selected from SiO₂ and B₂O₃, the network modifying oxides may be at least one oxide selected from alkali metal oxides and alkaline earth metal oxides, and part of TiO₂ may be replaced by Al₂O₃. In this case, the composition of the glass satisfies the following conditions:

40≦(M[SiO₂]+M[B2O₃])≦70;

5≦M[TiO₂]+M[Al₂O₃]≦45;

5≦M[TiO₂]; and

5≦(M[AMO]+M[AEMO])≦40,

wherein M[SiO₂], M[B₂O₃], M[AMO], M[AEMO], and M[Al₂O₃] denote the contents by percentage (mol %) for which SiO₂, B₂O₃, alkali metal oxides, alkaline earth metal oxides, and Al₂O₃ account in the composition, respectively.

From the viewpoint of allowing the laser processing threshold to decrease, the composition satisfies preferably a condition of 10≦M[TiO₂], more preferably a condition of 15≦M[TiO₂] (for instance, 20≦M[TiO₂]).

Examples of the combination of preferable oxides include SiO₂/B₂O₃/TiO₂/Na₂O, SiO₂/Al₂O₃/TiO₂/Na₂O, etc.

The compositions described above may be composed of the above-mentioned oxides alone. The compositions described above, however, may contain oxides other than the above-mentioned oxides as long as the effects of the present invention are provided. When such oxides are contained, the content by percentage thereof is, for instance, 20 mol % or less, and generally 10 mol % or less.

In the compositions described above, it is preferable that the average value fₘ of cation field strengths, the average value Fₘ of single bond strengths, and the number N of Si—O—Ti bonds satisfy the aforementioned preferable ranges, respectively. Furthermore, it also is preferable that the above-mentioned compositions satisfy preferable ranges of M[TiO₂]/M[SiO₂] and N_{BO}^{I}/α (or N_{BO}/α) to be described later.

### Embodiment 2

The present inventors further studied glass compositions and thereby found a glass that had a lower thermal expansion coefficient and was easy to laser-process among glasses each having a composition that contained titanium but was substantially free from alkali metal ions. The composition of this glass satisfies the following conditions:

40≦M[SiO₂]≦60;

10≦M[Al₂O₃]≦20;

10≦M[TiO₂]≦20; and

10≦M[MgO]≦35,

where M[MgO] denotes the content by percentage (mol %) for which MgO accounts in the composition.

Furthermore, it is more preferable that the glass composition according to Embodiment 2 satisfies the following conditions:

45≦M[SiO₂]≦55;

15≦M[Al₂O₃]≦20;

10≦M[TiO₂]≦15; and

10≦M[MgO]≦25.

Preferably, the glass according to Embodiment 2 is free from alkali metal oxides or contains alkali metal oxides whose content by percentage is very small. Even when the glass according to Embodiment 2 contains alkali metal oxides, the content by percentage thereof is, for instance, 5 mol % or less (preferably 3 mol % or less). It also is preferable that the glass according to Embodiment 2 be free from alkaline earth metal oxides other than MgO or contain alkaline earth metal oxides whose content by percentage is very small. Even when the glass according to Embodiment 2 contains alkaline earth metal oxides other than MgO, the content by percentage thereof is, for instance, 10 mol % or less (preferably 5 mol % or less).

A glass according to Embodiment 2 may be composed only of SiO₂, Al₂O₃, TiO₂, and MgO or may contain other oxides as long as the effects of the present invention can be provided. When such oxides are contained, the content by percentage thereof is, for instance, 5 mol % or less and generally 3 mol % or less.

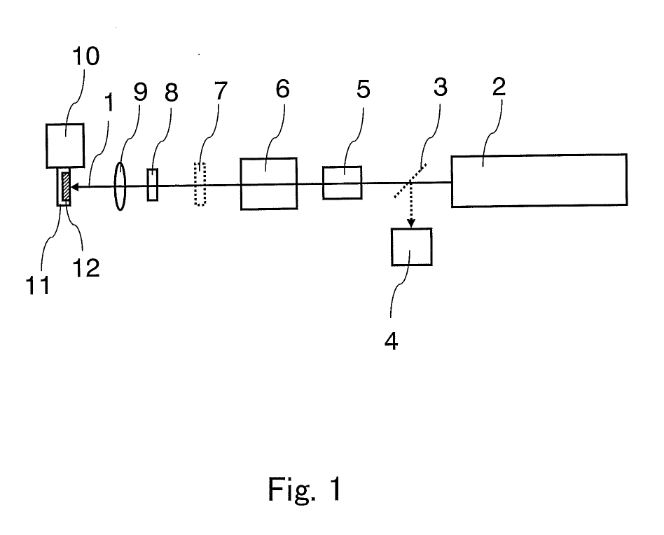

Preferred embodiments of the glass according to the present invention were described above. A glass for laser processing of the present invention can be processed with a lower power laser, and the inner portion of the glass also can be processed. From another aspect of the present invention, the present invention relates to a method of laser processing using a glass of the present invention. The laser processing can be carried out using a common processing apparatus, for instance, an apparatus including an optical system as shown in FIG. 1. The laser beam to be used for this laser processing is not particularly limited but is preferably one with a short wavelength (preferably the wavelength is 400 nm or shorter, for instance, 300 nm or shorter). The shorter the wavelength of a laser beam, the smaller the diameter of a focused beam. Accordingly, in this case, microprocessing can be carried out with high precision.

From still another aspect of the present invention, the present invention relates to a method of manufacturing a glass for laser processing. This manufacturing method is described below.

A glass that is manufactured by this manufacturing method contains a predetermined content by percentage of TiO₂ (generally 5 to 45 mol % and preferably 10 to 45 mol %, for instance, 15 to 45 mol %) as its component. Preferred components of a glass to be manufactured may be, for example, combinations of oxides described in Embodiments 1 and 2. Such a glass has a lower laser processing threshold and is suitable for processing with a laser beam having a short wavelength (for instance, in the ultraviolet region).

In this manufacturing method, the selection of the composition of a glass, i.e. the selection of the type and content by percentage of oxides to be included in a glass is made so that one value selected from the average value fₘ of cation field strengths, the average value Fₘ of single bond strengths, the number N of Si—O—Ti bonds, and the ratio of M[TiO₂]/M[SiO₂] is in a preferable range. For instance, the materials may be selected so that the value fₘ is 1.35 or lower or the value Fₘ is 400 kJ·mol⁻¹ or lower. With respect to a glass composed essentially of SiO₂, TiO₂, and at least one oxide selected from alkali metal oxides and alkaline earth metal oxides, the materials thereof may be selected so that the number N of Si—O—Ti bonds is at least 0.4. Furthermore, the materials of this glass may be selected so that a condition of 0.2≦M[TiO₂]/M[SiO₂]≦0.7 is satisfied. When the oxides and the contents by percentage thereof are selected so as to allow any of the above-mentioned values to be in the above-mentioned corresponding range, a glass can be obtained that has a lower laser processing threshold and that is easy to manufacture.

In this manufacturing method, a glass is formed so as to have a composition selected in the above-mentioned manner. The glass formation method is not particularly limited but for instance, a melting method or a vapor deposition method may be used. When a glass is manufactured by the melting method, a plurality of oxides are mixed together to be melted so that a selected composition is obtained, which then is cooled. Thus a glass for laser processing that is easy to laser-process can be obtained.

### EXAMPLES

Hereinafter, the present invention is described using examples.

### Example 1

Sixteen glasses whose compositions were different from one another were produced by the melting method. The compositions of the 16 glasses thus produced are indicated in Table 1. All the samples are glasses of a three-component system that is composed of SiO₂, TiO₂, and Na₂O. In order to clarify the relationship between the state of Si—O—Ti bonds and the laser processing threshold, examples of the simplest system are described here. The present invention, however, is not limited to the following examples.

TABLE 1

| | | | | α (λ: 266 | | |
|---|---|---|---|---|---|---|
| | Components (mol %) | | | nm) | Fₜₕ | Δh |
| Sample | SiO₂ | TiO₂ | Na₂O | (10⁴ cm⁻¹) | (mJ · cm⁻²) | (μm/shot) |
| 1 | 24.75 | 45 | 30.25 | 32.7 | 209 | 0.106 |
| 2 | 35 | 30 | 35 | 27.4 | 287 | 0.123 |
| 3 | 30 | 40 | 30 | 29.3 | 296 | 0.117 |
| 4 | 27.5 | 45 | 27.5 | 30.2 | 283 | 0.112 |
| 5 | 57 | 5 | 38 | 26.7 | 461 | 0.103 |
| 6 | 54 | 10 | 36 | 22.7 | 457 | 0.130 |
| 7 | 48 | 20 | 32 | 25.4 | 322 | 0.125 |
| 8 | 42 | 30 | 28 | 26.6 | 367 | 0.117 |
| 9 | 63.3 | 5 | 31.7 | 26.8 | 390 | 0.107 |
| 10 | 60 | 10 | 30 | 21.5 | 474 | 0.136 |
| 11 | 53.3 | 20 | 26.7 | 27.5 | 259 | 0.125 |
| 12 | 46.7 | 30 | 23.3 | 27.3 | 307 | 0.123 |
| 13 | 66.5 | 5 | 28.5 | 26.0 | 457 | 0.108 |
| 14 | 63 | 10 | 27 | 22.9 | 456 | 0.130 |
| 15 | 56 | 20 | 24 | 25.5 | 298 | 0.139 |
| 16 | 49 | 30 | 21 | 28.4 | 252 | 0.127 |

### Production of Sample

Raw materials were blended according to the compositions of samples 1 to 16 indicated in Table 1 so that each sample to be obtained was 200-g glass. The raw materials were put into a platinum crucible. Subsequently, this crucible was placed in a melting furnace whose temperature had been raised to 1250° C. to 1550° C. and then was maintained for 5 to 6 hours while the melt of the raw materials was stirred suitably. Then the melt was poured into a mold placed on an iron plate. Immediately thereafter, it was put into a furnace having a temperature of about 500° C. and was maintained at a predetermined temperature for 30 minutes to one hour. Subsequently, the inside of the furnace was cooled to room temperature over 16 hours. A glass block thus obtained was cut and polished by a common method and thereby a glass sheet whose both surfaces were smooth was obtained. This glass sheet was used as a sample for a laser-processing test.

### Laser Irradiation Test

Here, each sample was irradiated with a laser beam and thereby the laser processing threshold Fₜₕ was determined. The laser irradiation to the sample was carried out using the optical system shown in FIG. 1. The irradiation laser beam 1 used herein was 4^{th} harmonics (with a wavelength of 266 nm) of a Nd:YAG laser. The laser beam 1 having a repetition frequency of 20 Hz and a pulse width of 5 to 8 ns was supplied from a laser source 2.

In the case where the sample 12 was not to be irradiated with the laser beam 1, a mirror 3 was inserted on the optical path. The laser beam 1 reflected by the mirror 3 was absorbed by a damper 4. A Glan-Laser Prism 5 allows only light polarized in one direction to pass therethrough and therefore removes second harmonics (532 nm) having a different polarization direction from that of the 4^{th} harmonics. An attenuator 6 is inserted on the optical path to adjust laser beam intensity. The intensity of the laser beam 1 that had passed through the attenuator 6 was measured with a power meter 7.

In the case where the sample 12 was to be irradiated with the laser beam 1, the power meter 7 was removed from the optical path. A shutter 8 can be controlled remotely. The shutter 8 was opened at the start of laser irradiation to be carried out to the sample 12 and was closed at the end of the irradiation. The laser beam 1 that had passed through the shutter 8 that was open was focused through a lens 9 with a focal length of 10 cm. Then the sample 12 was irradiated with the laser beam 1 thus focused, from the direction perpendicular to the surface thereof. The sample 12 was attached to a sample holder 11 that was joined to an XYZ stage 10.

### Calculation of Laser Processing Threshold and Laser Processing Speed

The sample 12 was irradiated with the laser beam 1 while the XYZ stage 10 was moved linearly in a plane perpendicular to the optical axis at a constant speed. The laser fluence set in this case was at least the processing threshold Fₜₕ. The irradiation of the laser beam 1 allowed a groove to be formed at the sample surface. The number of laser shots to which an arbitrary spot of the groove was subjected was calculated using the repetition frequency of the laser beam 1, the travel speed of the XYZ stage 10, and the laser spot diameter, all of which were known.

In this case, the laser repetition frequency and the laser spot diameter were not changed throughout the laser processing test carried out in the present example regardless of other conditions such as laser power, etc. Thus the laser irradiation test was repeated while the travel speed of the stage is changed, and thereby a groove was formed at the sample surface by irradiated laser shots, the number of which varies according to places.

The dependency of the processing depth (a groove depth) on the number of laser shots can be proved by the above-mentioned laser irradiation test that is carried out while the travel speed of the stage is changed variously under a predetermined laser fluence. Generally, the processing depth is substantially proportional to the number of laser shots. Hence, from this proportion, the processing depth per shot, i.e. processing speed Δh can be determined. In this example, cross sections of several tens of spots per groove were measured with a three-dimensional shape measuring instrument and the average of the groove depths obtained by the measurements was considered as the processing depth.

With the above-mentioned method, the processing speed Δh to be obtained under various laser fluences can be determined and thereby the dependency of the processing speed Δh on the laser fluence can be proved. This dependency has been known to comply with the aforementioned formula (1) theoretically. Hence, in this example, the measurement results were applied to the formula (1) and fitting was carried out by the method of least squares. Thus the absorption coefficient α peculiar to a substance and an unknown laser processing threshold Fₜₕ were calculated.

### Evaluation Results

The absorption coefficient α, the laser processing threshold Fₜₕ, and the processing speed Δh (the processing speed obtained through irradiation of a laser whose power was 0.8 mJ) of each sample that were determined according to the formula (1) are indicated in Table 1. With respect to the laser processing thresholds Fₜₕ of the respective samples, there were about twofold differences depending on the compositions thereof. However, the thresholds Fₜₕ of all the samples of this example were far lower than that of soda-lime glass that is used for common window glasses, etc.

Table 2 indicates the average value fₘ of cation field strengths, the average value Fₘ of single bond strengths, the value Fₘ/α that was obtained through division of the value Fₘ by the absorption coefficient α, the number N of Si—O—Ti bonds, the ratio of M[TiO₂]/M[SiO₂], and the value N_{BO}^{I}/α (or N_{BO}/α) that was obtained through division of the number of bridging oxygen atoms by the absorption coefficient, of the respective samples.

TABLE 2

| | | | | | | | N_{BO}^{I}/α or |
|---|---|---|---|---|---|---|---|
| | | Fₘ | | | | M[TiO₂]/ | N_{BO}/α |
| Samples | fₘ | (kJ · mol⁻¹) | (kcal · mol⁻¹) | Fₘ/α | N | M[SiO₂] | (10⁻⁶ cm) |
| 1 | 1.154 | 341 | 81.5 | 0.087 | 3.040 | 1.818 | 2.94 |
| 2 | 1.239 | 365 | 87.2 | 0.111 | 1.714 | 0.857 | 7.31 |
| 3 | 1.188 | 350 | 83.7 | 0.100 | 2.333 | 1.333 | 5.70 |
| 4 | 1.165 | 344 | 82.2 | 0.095 | 2.636 | 1.636 | 4.52 |
| 5 | 1.414 | 427 | 102.1 | 0.134 | 0.175 | 0.088 | 9.97 |
| 6 | 1.379 | 413 | 98.7 | 0.152 | 0.370 | 0.185 | 11.75 |
| 7 | 1.316 | 390 | 93.1 | 0.128 | 0.833 | 0.417 | 10.51 |
| 8 | 1.259 | 371 | 88.7 | 0.117 | 1.381 | 0.714 | 9.84 |
| 9 | 1.418 | 429 | 102.5 | 0.134 | 0.158 | 0.079 | 11.19 |
| 10 | 1.386 | 415 | 99.3 | 0.162 | 0.333 | 0.167 | 13.97 |
| 11 | 1.326 | 393 | 93.9 | 0.119 | 0.750 | 0.375 | 10.90 |
| 12 | 1.271 | 375 | 89.6 | 0.115 | 1.142 | 0.642 | 10.45 |
| 13 | 1.419 | 429 | 102.6 | 0.138 | 0.150 | 0.075 | 12.09 |
| 14 | 1.388 | 417 | 99.6 | 0.152 | 0.317 | 0.159 | 13.74 |
| 15 | 1.330 | 395 | 94.3 | 0.129 | 0.714 | 0.357 | 12.33 |
| 16 | 1.276 | 377 | 90.0 | 0.111 | 1.041 | 0.612 | 10.41 |

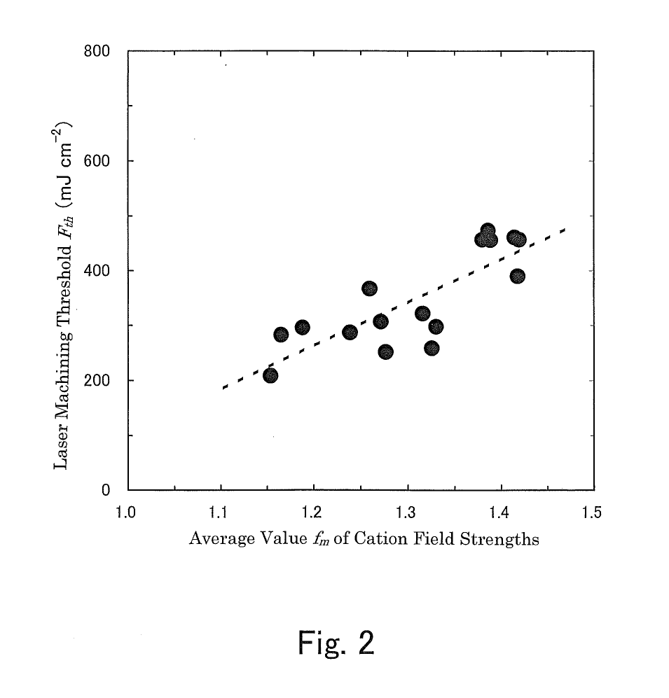

FIG. 2 shows the relationship between the laser processing threshold Fₜₕ and the average value fₘ of cation field strengths. The threshold Fₜₕ decreases with a decrease in the average value fₘ. In the case of the samples of this example, if a condition of fₐ≦1.35 is satisfied, the thresholds Fₜₕ obtained were about 400 mJ·cm⁻² or lower. In the samples of this example, laser processing can be carried out particularly easily when the threshold F^{th} is about 400 mJ·cm⁻² or lower. Accordingly, the criterion for judging the ease of laser processing was set at about 400 mJ·cm⁻².

FIG. 3 is a graph showing the relationship between the laser processing threshold Fₜₕ and the average value fₘ′ of all cation field strengths that was calculated, with the contribution of Na⁺ ions contained in the composition being included. Since no clear correlation is found between the average value fₘ′ and the threshold Fₜₕ, it can be understood that the cleavage of Na—O bonds formed with a lower bond strength does not affect the magnitude of the laser processing threshold. Accordingly, in the case of this example, it is necessary to determine the average value of cation field strengths, with the contributions of local fields formed by Na⁺ ions being excluded.

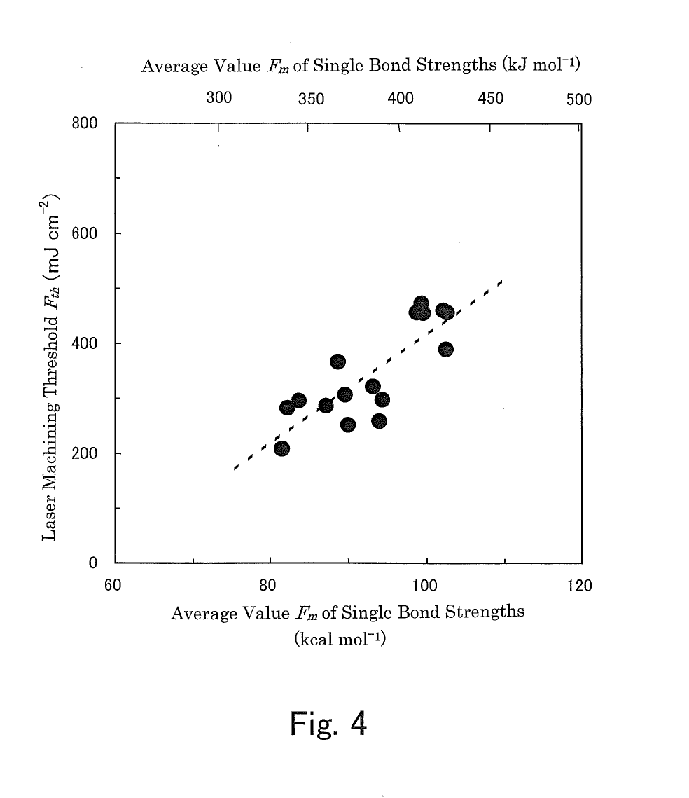

FIG. 4 shows the relationship between the laser processing threshold Fₜₕ and the average value Fₘ of single bond strengths. The threshold Fₜₕ decreases with a decrease in the average value Fₘ. In the case of the samples of this example, if a condition of Fₘ≦400kJ·mol⁻¹ (Fₘ≦95 kcal·mol⁻¹) is satisfied, the thresholds Fₜₕ obtained were about 400 mJ·cm⁻² or lower.

FIG. 5 shows the relationship between the laser processing threshold Fₜₕ and the average value Fₘ′ of all single bond strengths that was calculated, with the contribution of Na—O bonds being included. Since no clear correlation is found between the average value Fₘ′ and the threshold Fₜₕ, it can be understood that the cleavage of Na—O bonds formed with a lower bond strength does not affect the magnitude of the laser processing threshold. Accordingly, in the case of this example, it is necessary to determine the average value of single bond strengths, with the contributions of the Na—O bonds being excluded.

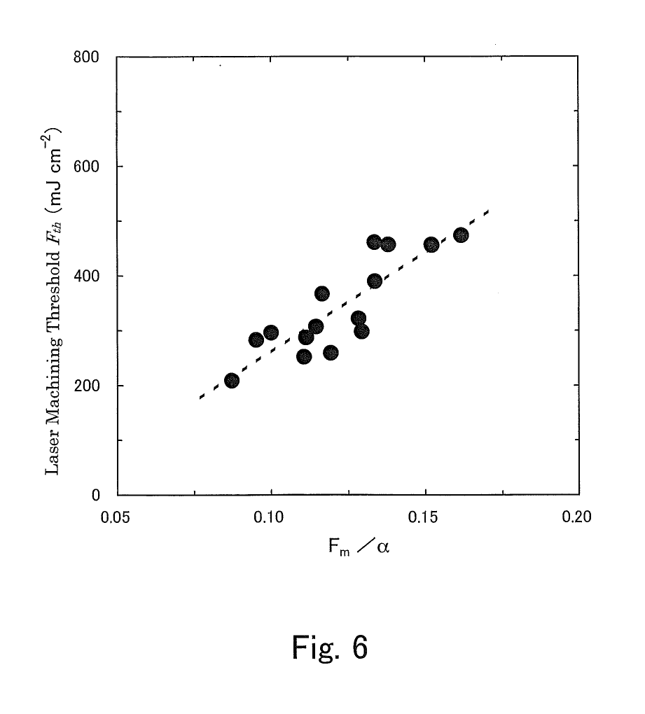

FIG. 6 shows the relationship between the laser processing threshold Fₜₕ and the value Fₘ/α obtained by dividing the average value Fₘ of single bond strengths by the absorption coefficient α. The threshold Fₜₕ decreases with a decrease in the value Fₘ/α. In the case of the samples of this example, if a condition of Fₘ/α≦0.13 is satisfied, the thresholds Fₜₕ obtained were about 400 mJ·cm⁻² or lower.

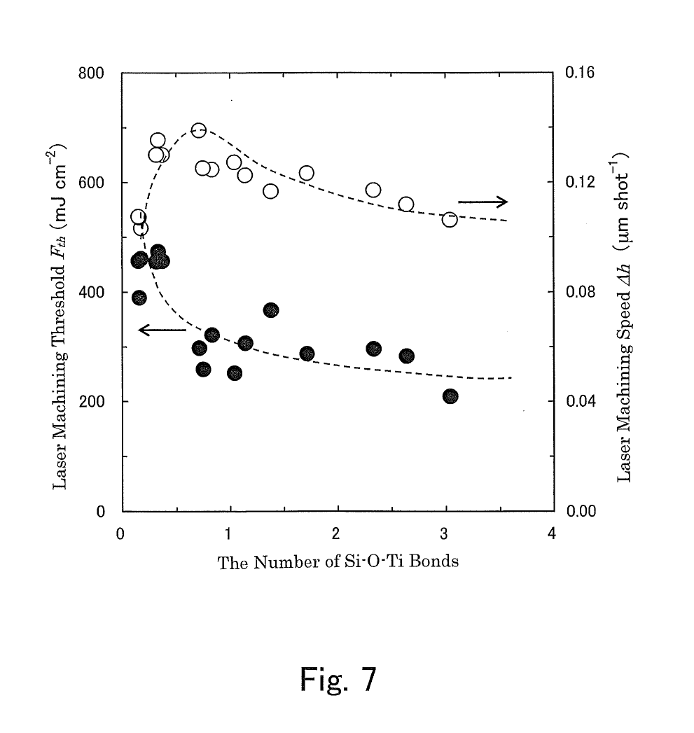

In FIG. 7, black dots indicate the relationship between the number N of Si—O—Ti bonds per SiO₄ unit and the laser processing threshold Fₜₕ while white dots indicate the relationship between the number N and the laser processing speed Δh. The threshold Fₜₕ decreases with an increase in the number N. In the case of the samples of this example, if a condition of 0.4≦N is satisfied, the thresholds Fₜₕ obtained were about 400 mJ·cm⁻² or lower.

However, when the number N exceeds 1.3, the degree to which the threshold Fₜₕ decreases with the increase in the number N diminishes gradually. The number N satisfies a condition of 0≦N≦4. Accordingly, in the case of the compositions of this example, the minimum threshold Fₜₕ that is obtained through a composition adjustment is predicted to be about 200 mJ·cm⁻². On the other hand, the dependency of the laser processing speed Δh on the number N has a maximum peak. In the region where the number N is excessively large, the laser processing speed Δh is slow and thereby the glass is difficult to laser-process. Thus, in order to obtain both a lower threshold Fₜₕ and a higher laser processing speed Δh, it is preferable that the number N satisfy a condition of 0.4≦N≦1.3.

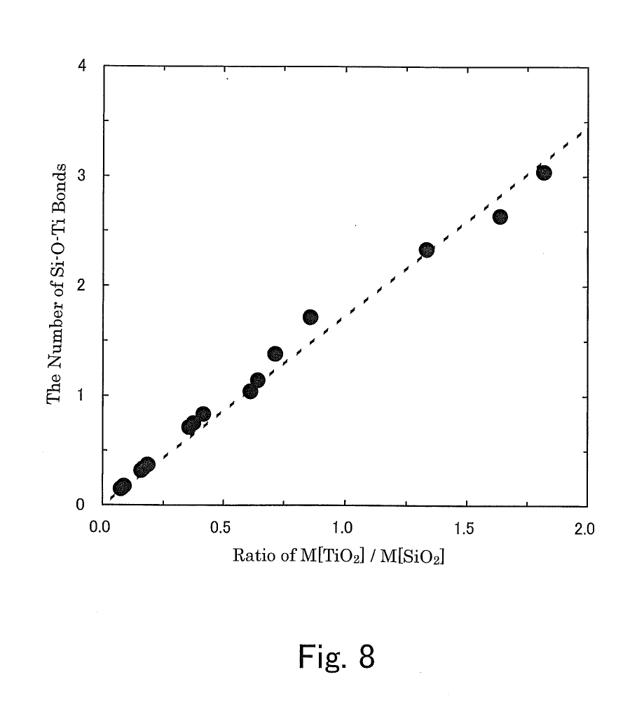

FIG. 8 shows the relationship between the number N of Si—O—Ti bonds and the ratio of M[TiO₂]/M[SiO₂]. As is clear from FIG. 8, the number N is substantially proportional to the ratio of M[TiO₂]/M[SiO₂]. Accordingly, it can be expected that the relationships between the ratio of M[TiO₂]/M[SiO₂] and the laser processing threshold Fₜₕ as well as the laser processing speed Δh tend to be similar to the relationships between the number N and them.

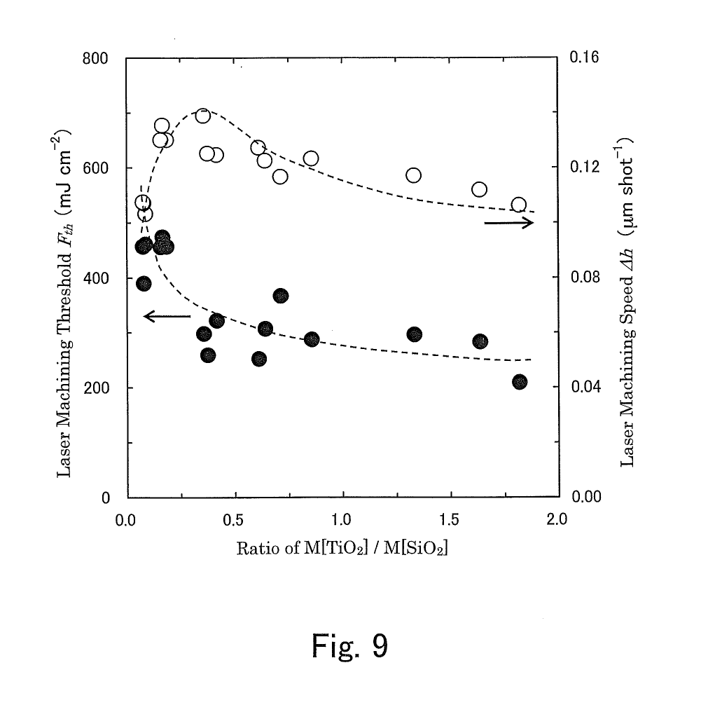

In FIG. 9, black dots indicate the relationship between the ratio of M[TiO₂]/M[SiO₂] and the laser processing threshold Fₜₕ while white dots indicate the relationship between the ratio of M[TiO₂]/M[SiO₂] and the laser processing speed Δh. As is clear from FIG. 9, in order to obtain both a lower threshold Fₜₕ and a higher laser processing speed Δh, it is preferable that a condition of 0.2≦M[TiO₂]/M[SiO₂]≦0.7 be satisfied.

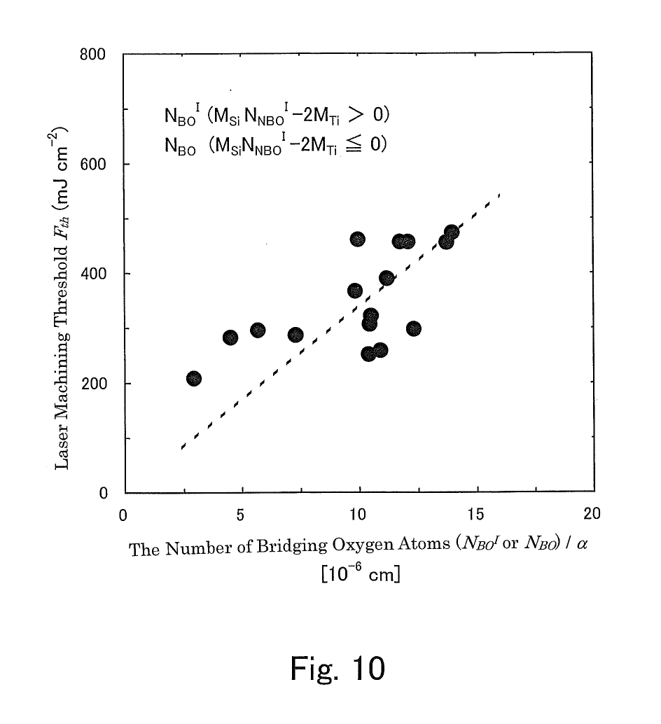

FIG. 10 shows the relationship between the laser processing threshold Fₜₕ and a value (N_{BO}^{I}/α or N_{BO}/α) obtained by dividing the number of bridging oxygen atoms by the absorption coefficient α. When M_{Si}N_{NBO}^{I}−2M_{Ti}>0, the value N_{BO}^{I} was used as the number of bridging oxygen atoms. On the other hand, when M_{Si}N_{NBO}^{I}−2M_{Ti}≦0, the value N_{BO} was used as the number of bridging oxygen atoms. The threshold Fₜₕ decreased with a decrease in the value N_{BO}^{I}/α or N_{BO}/α. In the case of the samples of this example, if the value N_{BO}^{I}/α or N_{BO}/α is 11×10⁻⁶ cm or lower, the thresholds Fₜₕ obtained were about 400 mJ·cm⁻² or lower.

With respect to the composition of a glass for laser processing, the following can be deduced from the above example.

The TiO₂ content by percentage M[TiO₂] (mol %) that satisfies a condition of 10≦M[TiO₂]≦45 allows the laser processing threshold particularly to decrease. When the TiO₂ content by percentage was less than 10 mol %, not much effect of decreasing the processing threshold value was obtained. On the other hand, when the TiO₂ content by percentage exceeded 45 mol %, it was difficult to obtain a bulk of glass by the melting method (radiational cooling of a melt). In order to decrease the laser processing threshold, the TiO₂ content by percentage is preferably at least 15 mol %, more preferably at least 20 mol %. When the TiO₂ content by percentage exceeded about 30 mol %, the decrease in the processing threshold tended to stop while the processing speed tended to decrease. Accordingly, it is further preferable that the TiO₂ content by percentage satisfy a condition of 10≦M[TiO₂]≦30.

Furthermore, it is preferable that the SiO₂ content by percentage M[SiO₂] (mol %) satisfy a condition of 20≦M[SiO₂]≦70. In order to form the network of a glass, the SiO₂ content by percentage M[SiO₂] needs to be at least 20 mol %. In addition, when it exceeds 70 mol %, the glass is difficult to melt.

The content by percentage of Na₂O M[Na₂O] (mol %) that is an alkali metal oxide satisfies preferably a condition of 5≦M[Na₂O]≦40, more preferably 20≦M[Na₂O]≦40.

In the example described above, glasses of a three-component system composed of SiO₂, TiO₂, and Na₂O were used. However, the above-mentioned preferable composition ranges also can be applied to glasses of a system containing components other than these three components.

Like SiO₂, B₂O₃ also is a network forming oxide that forms the network structure of a glass. It also acts as a solvent in melting a glass. Like Na₂O, alkali metal oxides other than Na₂O that include Li₂O, K₂O, Rb₂O, and Cs₂O as well as alkaline earth metal oxides that include MgO, CaO, SrO, and BaO also are glass network modifying oxides and have an effect of cleaving part of the glass network structure when being contained in the composition. These oxides also have effects of lowering the viscosity of a glass melt, etc.

Like TiO₂, Al₂O₃ is an intermediate oxide having intermediate properties between those of the glass network forming oxides and those of the glass network modifying oxides. When a suitable amount of Al₂O₃ is included in the composition, water resistance and chemical resistance of the glass can be improved.

With consideration given to the above points, in a glass for laser processing containing the components described above, preferable composition ranges are as follows:

40≦(M[SiO₂]+M[B₂O₃])≦70;

5≦M[TiO₂]+M[Al₂O₃]≦45;

5≦M[TiO₂]; and

5≦M[AMO]+M[AEMO]≦40.

M[AMO] denotes the sum of the contents by percentage of alkali metal oxides (mol %). The alkali metal oxides are Li₂O, Na₂O, K₂O, Rb₂O, and Cs₂O.

M[AEMO] denotes the sum of the contents by percentage of alkaline earth metal oxides (mol %). The alkaline earth metal oxides are MgO, CaO, SrO, and BaO.

Moreover, when a glass is produced by the melting method, it is preferable that the composition be adjusted so as to satisfy a relationship of M[TiO₂]/(M[B₂O₃]+M[TiO₂])≧0.5. When this relationship is satisfied, a glass is easy to form.

In order to obtain both a lower processing threshold and a higher processing speed, it is preferable that TiO₂ be introduced so that a relationship of 0.2≦M[TiO₂]/(M[SiO₂]+M[B₂O₃])≦0.7 is satisfied.

When a glass that satisfies the above-mentioned conditions concerning the composition is to be produced by the melting method, a slight amount of, for instance, Sb₂O₃ that is known as a clarifier may be added. Furthermore, the glass with the above-mentioned composition may be produced by a method other than the melting method, for instance, a vapor deposition method, etc.

### Example 2

In Example 2, a glass of Embodiment 2 was produced by the melting method. In Example 2, samples were produced in the same manner as in Example 1 except that the compositions of the samples and the temperature of the melting furnace used in producing the samples were different from those employed in Example 1. In Example 2, the temperature of the melting furnace used in producing the samples was set at 1620° C. The laser irradiation conditions employed for sample evaluations were the same as in Example 1.

Table 3 indicates the compositions of four types of samples (Samples 17 to 20) produced by the melting method. Table 3 also includes glass transition points Tg, linear thermal expansion coefficients β obtained at 50 to 350° C., and laser processing thresholds Fₜₕ determined using Formula (1) of the respective samples. All the samples were glasses of a four-component system composed of SiO₂, Al₂O₃, TiO₂, and MgO. In order to clarify the relationship between the glass composition and the thermal expansion coefficient, samples of the simplest system are described in Example 2. The components of the glass according to the present invention, however, is not limited to those of the following samples.

TABLE 3

| Sam- | Components (mol %) | | | | Tg | β | Fₜₕ |
|---|---|---|---|---|---|---|---|
| ples | SiO₂ | Al₂O₃ | TiO₂ | MgO | (° C.) | (10⁻⁷° C.⁻¹) | (mJ · cm⁻²) |
| 17 | 55 | 20 | 10 | 15 | 769 | 36 | 500 |
| 18 | 50 | 20 | 15 | 15 | 740 | 39 | 390 |
| 19 | 45 | 20 | 15 | 20 | 735 | 44 | 400 |
| 20 | 45 | 15 | 15 | 25 | 730 | 51 | 430 |

First, the composition range of TiO₂ is discussed. As is clear from FIG. 9, from the viewpoint of lowering the laser processing threshold, it is preferable that the content of TiO₂ be larger. TiO₂ whose amount is at least 10 mol % allows a lower threshold Fₜₕ to be obtained. On the other hand, in the glass compositions composed of four components of SiO₂, Al₂O₃, TiO₂, and MgO, TiO₂ whose amount is 20 mol % or lower allows a glass to be produced particularly easily. Hence, it is preferable that the amount of TiO₂ be in the range of 10 mol % to 20 mol %. When the amount of TiO₂ is larger than 15 mol %, it gradually becomes difficult to manufacture a glass with the increase in amount of TiO₂. It therefore is further preferable that the amount of TiO₂ be in the range of 10 mol % to 15 mol %. The laser processing thresholds Fₜₕ of the samples of this example were 500 mJ·cm⁻² or lower and were far lower than the threshold Fₜₕ of soda-lime glass that is used for common window glasses, etc.

Among glass network modifying oxides, MgO that is a glass network modifying oxide is known as a component that tends not to increase the thermal expansion coefficient. However, as is clear from Table 3, the increase in the amount of MgO resulted in an increase in thermal expansion coefficient β. In the glass compositions of Example 2 that each were composed of four components of SiO₂, Al₂O₃, TiO₂, and MgO, MgO whose amount was 25 mol % or less allowed the thermal expansion coefficient β to be about 50×10⁻⁷° C.⁻¹ or lower. Furthermore, as indicated in Table 3, a small amount of SiO₂ that was a glass network forming oxide resulted in an increase in thermal expansion coefficient. In the glasses with the compositions of Example 2, SiO₂ whose amount was at least 45 mol % allowed the thermal expansion coefficient β to be about 50×10⁻⁷° C.⁻¹ or lower.

In addition, when the amount of MgO is in the range of 10 mol % to 35 mol % and the amount of SiO₂ is in the range of 40 mol % to 60 mol %, a glass is easy to manufacture. For instance, under the manufacturing conditions of Example 2, it was possible to form a glass with a composition of M[SiO₂]:M[Al₂O₃]:M[TiO₂]:M[MgO]=40:10:15:35. On the other hand, under the same manufacturing conditions, it was not possible to form glasses with a composition of M[SiO₂]:M[Al₂O₃]:M[TiO₂]:M[MgO]=30:15:15:40, a composition of M[SiO₂]:M[Al₂O₃]:M[TiO₂]:M[MgO]=35:10:15:40, and a composition of M[SiO₂]:M[Al₂O₃]:M[TiO₂]:M[MgO]=35:15:15:35. Hence, the amount of MgO is preferably in the range of 10 mol % to 35 mol % while the amount of SiO₂ is preferably in the range of 40 mol % to 60 mol %.

In the glasses with the compositions of Example 2, Al₂O₃ whose amount is in the range of 10 mol % to 20 mol % facilitates the manufacture of a glass. Accordingly, the amount of Al₂O₃ is preferably in the range of 10 mol % to 20 mol %. Like TiO₂, Al₂O₃ is an intermediate oxide. When a suitable amount of Al₂O₃ is contained in the composition, water resistance and chemical resistance of the glass can be improved.

When a glass that satisfies the above-mentioned conditions concerning the composition is produced by the melting method, a slight amount of, for instance, Sb2O₃ that is known as a clarifier may be added. Furthermore, a slight amount of, for instance, CeO₂ may be added as an oxidizer. For example, when a suitable amount of CeO₂, typically about 0.5 mol % to 2 mol %, is added to a batch, the amount of Ti³⁺ contained in the glass can be reduced. As a result, the light transmittance with respect to a wavelength around 500 nm to 1000 nm can be improved without changing the laser processing threshold and processing speed considerably. Furthermore, the glasses with the above-mentioned compositions may be produced by a method other than the melting method, for instance, the vapor deposition method.

In Examples 1 and 2, laser processing was carried out using sheet samples. The glass for laser processing of the present invention, however, has excellent laser processability regardless of the shape thereof. Accordingly, the shape of the glass is not limited to a sheet shape. For instance, the glass may be produced in the form of rod, glass flakes, glass fibers or glass fabric.

### INDUSTRIAL APPLICABILITY

The present invention provides a glass for laser processing in which not only the vicinity of its surface but also the inner portion thereof can be laser-processed. Since the glass of the present invention has a lower laser processing threshold, the input of laser energy that is required for laser processing can be reduced and the glass is easy to process. Furthermore, the present invention also provides a glass for laser processing with a lower thermal expansion coefficient in which the inner portion thereof also can be laser-processed easily. The glass for laser processing of the present invention can be used as various glasses that are to be processed with a laser. The glass for laser processing of the present invention can be applied to, for instance, circuit boards, optical elements, heads for ink jet printers, masks for printing, molds to be used for forming optical elements, filters, catalyst supports, joint elements for optical fibers, and glass chips for chemical analysis. The use of the glass according to the present invention, however, is not limited thereto.

1-8. (canceled)

9. A method of processing a glass, the method comprising:
processing the glass by applying a laser beam to the glass,
wherein the glass has a composition that satisfies the following relationships:
40≦M[NFO]≦70;
20≦(M[TiO₂])≦45; and
5≦M[NMO]≦40,
where M[NFO], M[TiO₂], and M[NMO] denote the content by percentage of network forming oxides (mol %), that of TiO₂ (mol %), and that of network modifying oxides (mol %), respectively,
the composition contains 20 to 40 mol % of Na₂O, and
the composition essentially is free from Y₂O₃.

10. The method according to claim 9, wherein an inner portion of the glass is processed by applying the laser beam to the glass.

11. The method according to claim 9, wherein the glass is not a crystallized glass.

12. A method of processing a glass, the method comprising:
processing the glass by applying a laser beam to the glass so that an inner portion of the glass is processed,
wherein the glass has a composition that satisfies the following conditions:
45≦M[SiO₂]≦55;
15≦M[Al₂O₃]≦20;
10≦M[TiO₂]≦15; and
10≦M[MgO]≦25,
where M[SiO₂], M[Al₂O₃], M[TiO₂], and M[MgO] denote the content by percentage of SiO₂ (mol %), that of Al₂O₃ (mol %), that of TiO₂ (mol %), and that of MgO (mol %), respectively, and
the composition essentially is free from Y₂O₃.

13. The method according to claim 12, wherein the glass consists essentially of 45 to 55 mol % of SiO₂, 15 to 20 mol % of Al₂O₃, 10 to 15 mol % of TiO₂, 10 to 25 mol % of MgO, 0 to 5 mol % of alkali metal oxides, and 0 to 10 mol % of alkaline earth metal oxides other than MgO.

14. The method according to claim 12, wherein the glass is not a crystallized glass.
